(19) United States
(12) Patent Application Publication
(10) Pub. No.: US 2026/0292394 A1
(43) Pub. Date: Sep. 24, 2026

(54) Valved Port

(71) Applicant: Apple Inc., Cupertino, CA (US)

(72) Inventors: Lucas Vindrola, San Francisco, CA (US); Andrew M. Hulva, Gilroy, CA (US); Onur I. Ilkorur, Santa Clara, CA (US)

(21) Appl. No.: 19/083,043

(22) Filed: Mar. 18, 2025

(51) Int. Cl. H04R 1/28

(52) U.S. Cl. CPC H04R 1/2849

(57) ABSTRACT

An electronic device comprising: an enclosure having an enclosure wall that forms a back volume chamber around a transducer and an acoustic tube coupling the back volume chamber to an environment surrounding the enclosure wall; and a valve coupled to the acoustic tube and operable to automatically tune the acoustic tube in response to a sound pressure level of the transducer.

### BACKGROUND

### FIELD

An aspect of the disclosure is directed to a transducer having a ported back volume chamber that is dynamically tuned in response to a sound pressure level. Other aspects are also described and claimed.

### BACKGROUND INFORMATION

Electronic devices (e.g., desktop computers, desktop speakers, smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, to output sound pressure waves corresponding to sounds associated with music or a game the user wishes to play. Due to the relatively low profile of these electronic devices, the transducers also have a relatively low profile, which in turn, can make it difficult to maintain optimal sound quality.

### SUMMARY

An aspect of the disclosure is directed to a ported transducer enclosure in which the resonance can be tuned as a function of sound pressure level. For example, the port may be opened, closed, or otherwise modified in response to a volume or sound pressure level of the transducer to tune the resonance. Representatively, one limiting factor for low frequency (LF) reproduction at high sound pressure levels (SPL) is the excursion of the transducer’s moving mass (e.g., diaphragm). For a fixed acoustic radiating area, the sound pressure generated by the loudspeaker is proportional to its excursion, up to an excursion limit, where no more excursion can be realized and the sound pressure level cannot be further increased. Said another way, when the transducer is coupled to a closed back volume, there is a limited or finite amount of air it can move by excursion which in turn results in a finite amount of sound pressure it can produce. Porting the enclosure surrounding the transducer to the ambient environment, specifically opening the transducer back volume to the ambient environment, helps to increase the low frequency sound pressure potential for the same given transducer and excursion limit. In the ported-enclosure or box system, however, a fourth-order low frequency roll-off occurs, as compared to a second order low frequency roll-off when the port is omitted (e.g., a closed box system). Thus, at low overall sound pressure levels, for example, when the transducer volume knob is turned down from a maximum volume, this fourth order roll-off limits the low frequency output and decreases potential frequency bandwidth. Accordingly, at high or loud volumes or sound pressure levels, it is desirable to have a port that is open to the back volume chamber of the transducer to increase the low frequency output at high volumes, while at low volumes it is desirable to have a closed back volume chamber to further optimize the low frequency output at lower volumes. Thus, the instant disclosure provides a ported enclosure in which the port may be a tube that acts as a resonator that may be tuned to increase the low frequency output. For example, the tube may have a specific size, shape, geometry, length or other characteristics that are selected based on the enclosure size so that the tube has a specific surface area or air volume that interacts with the volume trapped inside the enclosure. The resonance frequency of the tube can be tuned by changing a geometry, surface area, volume, etc. of the tube in response to the system volume or sound pressure level as described herein to optimize the low frequency output at both high and low transducer volumes. Representatively, in some aspects, an active valve or other mechanism may be coupled to the port or tube to automatically or dynamically open, close or otherwise modify the volume or surface area of the port or tube between the transducer back volume and surrounding environment. For example, the valve may be a solenoid valve, a sliding gate valve, a micro-electromechanical valve or any other type of active valve mechanism that can open, close or otherwise modify the surface area or volume of the port or tube in response to a sound pressure level or system volume. In addition, in some aspects, the port or tube may include a number or ports or tubes that together make up a total surface area or air volume between the back volume chamber and the environment that can be tuned or modified by the valve.

Representatively, in some aspects, an electronic device includes an enclosure having an enclosure wall that forms a back volume chamber around a transducer and an acoustic tube coupling the back volume chamber to an environment surrounding the enclosure wall; and a valve coupled to the acoustic tube and operable to automatically tune the acoustic tube in response to a sound pressure level of the transducer. In some aspects, the acoustic tube includes a first end having a first opening to the environment and a second end having a second opening to the back volume. In still further aspects, the valve transitions to an open configuration to maximize an air volume of the acoustic tube in response to a maximum sound pressure level. In some aspects, in the open configuration, a first end of the acoustic tube is open to the environment and a second end of the acoustic tube is open to the back volume chamber. In other aspects, the valve transitions to a closed configuration to minimize an air volume of the acoustic tube in response to a minimum sound pressure level. In some aspects, in the closed configuration, a first end of the acoustic tube is closed to the environment or a second end of the acoustic tube is closed to the back volume chamber by the valve. In some aspects, the acoustic tube is a first acoustic tube and the device further comprises a second acoustic tube that together define a total air volume coupling the back volume to the environment that is tuned in response to the sound pressure level. In still further aspects, the valve is a first valve coupled to the first acoustic tube and a second valve is coupled to the second acoustic tube, and the first valve and the second valve transition to an open configuration to maximize the total air volume of the first acoustic tube and the second acoustic tube in response to a maximum sound pressure level. In other aspects, the valve is a first valve coupled to the first acoustic tube and a second valve is coupled to the second acoustic tube, and the first valve and the second valve transition to a closed configuration to minimize the total air volume of the first acoustic tube and the second acoustic tube in response to a minimum sound pressure level. In still further aspects, the valve is a first valve coupled to the first acoustic tube and a second valve is coupled to the second acoustic tube, the first valve opens the first acoustic tube and the second valve closes the second acoustic tube in response to a sound pressure level between a maximum sound pressure level and a minimum sound pressure level. In some aspects, the valve includes a sliding member having an open portion and a closed portion that slide across open ends of the first acoustic tube and the second acoustic tube to tune the total air volume of the first acoustic tube and the second acoustic tube in response to the sound pressure level. In some aspects, the sliding member slides to a number of different positions to open or close the first acoustic tube and the second acoustic tube in response to a number of different sound pressure levels between a maximum sound pressure level and a minimum sound pressure level. In some aspects, the sliding member slides in a direction perpendicular to an axis of the first acoustic tube and the second acoustic tube to tune the total air volume of the first acoustic tube and the second acoustic tube.

In other aspects, an electronic device includes an enclosure having an interior chamber and an acoustic pathway coupling the interior chamber to an environment surrounding the enclosure; a speaker coupled to the enclosure, the speaker having a sound output side that outputs sound to the environment surrounding the enclosure and a back side acoustically coupled to the interior chamber and the acoustic pathway; and a valve coupled to the acoustic pathway and operable to automatically modify an air volume of the acoustic pathway in response to a sound pressure level of the speaker. In some aspects, the valve is operable to automatically increase the air volume of the acoustic pathway by opening the acoustic pathway to the environment in response to a maximum sound pressure level of the speaker. In other aspects, the valve is operable to automatically decrease the air volume of the acoustic pathway by closing the acoustic pathway to the environment in response to a minimum sound pressure level of the speaker. In still further aspects, the acoustic pathway includes a number of acoustic tubes that together define a total air volume coupling the back volume to the environment that is tuned in response to the sound pressure level. In some aspects, the valve reduces the total air volume of the acoustic pathway by closing at least one acoustic tube of the number of acoustic tubes in response to a reduction in the sound pressure level from a maximum sound pressure level. In other aspects, the valve increases the total air volume of the acoustic pathway by opening at least one acoustic tube of the number of acoustic tubes in response to an increase in the sound pressure level from a minimum sound pressure level. In still further aspects, the valve includes a sliding member having an open portion and a closed portion that slide to a number of different positions to open or close the number of acoustic tubes and increase or decrease the total air volume.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

FIG. 1 illustrates a cross-sectional side view of one aspect of an electronic device.

FIG. 2 illustrates a frequency response curve of one aspect of an electronic device.

FIG. 3 illustrates a cross-sectional side view of one aspect of an electronic device.

FIG. 4 illustrates a cross-sectional side view of one aspect of an electronic device.

FIG. 5 illustrates a cross-sectional side view of one aspect of an electronic device.

FIG. 6 illustrates a cross-sectional side view of one aspect of an electronic device.

FIG. 7 illustrates a cross-sectional side view of one aspect of an electronic device.

FIG. 8 illustrates a cross-sectional side view of one aspect of an electronic device.

FIG. 9 illustrates a cross-sectional side view of one aspect of an electronic device.

FIG. 10 illustrates a representative process for dynamically tuning a transducer including the valve assembly of FIGS. 1-9.

FIG. 11 illustrates a block diagram of one aspect of an electronic device within which a transducer including the valve assembly of FIGS. 1-9 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as "beneath", "below", "lower", "above", "upper", and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" or "beneath" other elements or features would then be oriented "above" the other elements or features. Thus, the exemplary term "below" can encompass both an orientation of above and below. The device may be otherwise oriented (e.g., rotated 90 degrees or at other orientations) and the spatially relative descriptors used herein interpreted accordingly.

As used herein, the singular forms "a", "an", and "the" are intended to include the plural forms as well, unless the context indicates otherwise. It will be further understood that the terms "comprises" and/or "comprising" specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

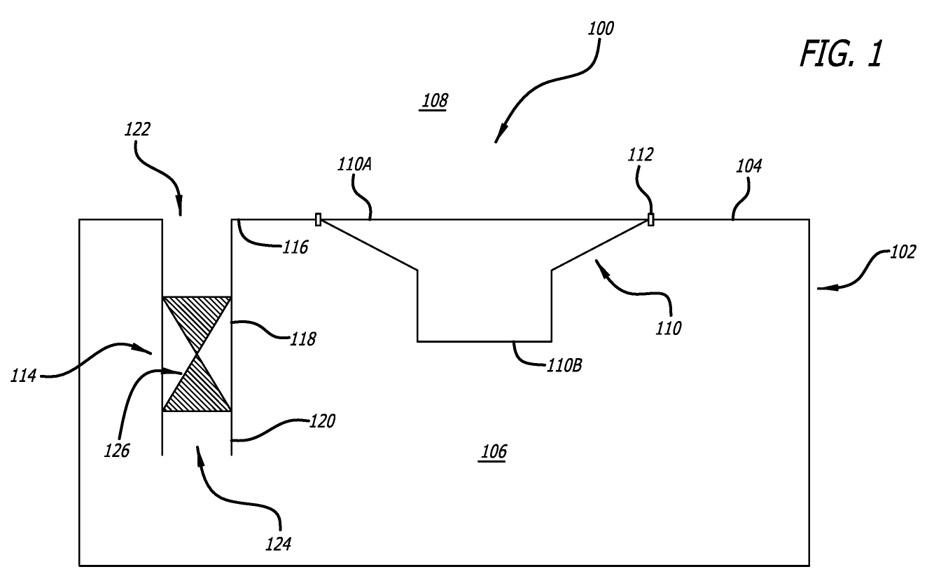

FIG. 1 illustrates a cross-sectional side view of one aspect of an electronic device. The electronic device 100 may include a housing, casing or outer enclosure 102 that defines or closes off a chamber in which the constituent electronic components of electronic device 100 are contained. In some aspects, it is contemplated that device 100 may be a desk top device, a portable or mobile communications device, an in-ear device, portable time piece or any other device within which a transducer may be implemented. Enclosure 102 may include an enclosure wall 104 that separates a surrounding ambient environment from an encased space or interior chamber 106 formed within enclosure 102. In some cases, the enclosure wall 104 completely isolates or seals the entire, or a portion of, interior chamber 106 from the surrounding environment 108. For example, the enclosure wall 104 may form a water-proof or acoustically isolated portion of interior chamber 106 which is impermeable to water and /or air. The interior chamber 106 may be of a sufficient volume and/or size to accommodate the constituent components of electronic device 100. The enclosure wall 104 may also include one or more of an acoustic opening 112 coupled to a sound output (or input) side of a transducer 110 positioned in the interior chamber 106. Representatively, in one aspect shown in FIG. 1, enclosure acoustic opening 112 is an acoustic opening that is acoustically open to a transducer 110 positioned within interior chamber 106 and the surrounding ambient environment 108. In some aspects, transducer 110 may be any type of electroacoustic transducer capable of converting an electrical audio signal into a sound or a sound into an electrical audio signal. Representatively, transducer 110 may be a speaker that uses a moving coil motor to drive sound output. In other aspects, where transducer 110 converts sound into an electrical audio signal, it may further be referred to herein as a microphone. In the case where transducer 110 is a speaker, the speaker may have a sound output face or surface 110A that outputs sound through opening 112 to the surrounding ambient environment 108. Although not shown, in some aspects, there may be an acoustic volume or chamber such as a front volume chamber between the sound output face 110A of transducer 110 and ambient environment 108. In this aspect, sound pressure waves output from surface 110A of transducer 110 may pass through opening 112 and the front volume chamber to the surrounding ambient environment 108. Interior chamber 106 may, on the other hand, surround or otherwise be coupled to a back side 110B of transducer 110 that is contained within enclosure 102. In this aspect, interior chamber 106 may also be referred to herein as a back volume chamber that defines an acoustic volume surrounding the back side 110B of transducer 110.

It is recognized that, for example, a size, volume, pressure or other aspects of interior chamber 106 may impact the acoustic performance of transducer 110. Thus, modifying the size, volume, pressure and/or resonance of chamber 106 may be used to tune or optimize the acoustic performance of transducer 110. For example, in some cases, it may be desirable for chamber 106 to be open to the surrounding ambient environment 108. In other cases, it may be desirable for chamber 106 to be isolated or sealed from the ambient environment 108 to achieve the desired acoustic performance at certain frequencies. Representatively, to optimize a low frequency output when the transducer or speaker is at a maximum volume level, it may be desirable to open the chamber 106 to the environment 108. On the other hand, to optimize a low frequency output at lower volumes, it may be desirable to close or isolate chamber 106 from environment 108. In this aspect, an acoustic pathway 114 including a valve assembly 126 to tune pathway 114 may further be provided between chamber 106 and the surrounding ambient environment 108. Pathway 114 may have a size, geometry, surface area, air volume or other aspect specifically selected based on a size of chamber 106 that allows the pathway to act as a resonator having a desired resonance frequency that optimizes the transducer output at different volumes. Representatively, acoustic pathway 114 may be an acoustic port, channel and/or tube formed by, or coupled to, enclosure wall 104. For example, pathway 114 may include a first end 116 and a second end 120 that are connected by an elongated portion 118 that extends from enclosure wall 104 into chamber 106. First end 116 may have an opening 122 formed through enclosure wall 104 and that is open to environment 108, and a second end 120 having an opening 124 that is open to chamber 106. Openings 122, 124 and/or elongated portion 118 may have a size, geometry and/or surface area selected based on the volume of chamber 106 to achieve the desired resonance frequency.

Valve assembly 126 may be coupled to pathway 114 and configured to tune, manipulate or otherwise change a characteristic of pathway 114 connecting chamber 106 to the surrounding environment 108. Representatively, valve assembly 126 may be configured to transition between open and closed positions which change the surface area, size and/or geometry of pathway 114 coupled to chamber 106 and/or surrounding environment 108. For example, in the open position, valve assembly 126 may uncover or otherwise not occlude opening 122, opening 124 or elongated portion 118 of pathway 114 to maximize the pathway surface area and air volume from environment 108 interacting with chamber 106. On the other hand, in the closed position, valve assembly 126 may cover or occlude opening 122, opening 124 or elongated portion 118 of pathway 114 to minimize the pathway surface area and/or air volume from environment 108 interacting with chamber 106. Valve assembly 126 may be any type of valve that can be configured to transition between the open and closed positions in response to a volume level or sound pressure level of transducer 110. Representatively, valve assembly 126 may be an active valve, for example a solenoid valve or a micro-electromechanical valve, that is connected to opening 122, opening 124 and/or portion 118 and operable to open or close when a voltage is applied in response to a volume level or sound pressure level of transducer 110.

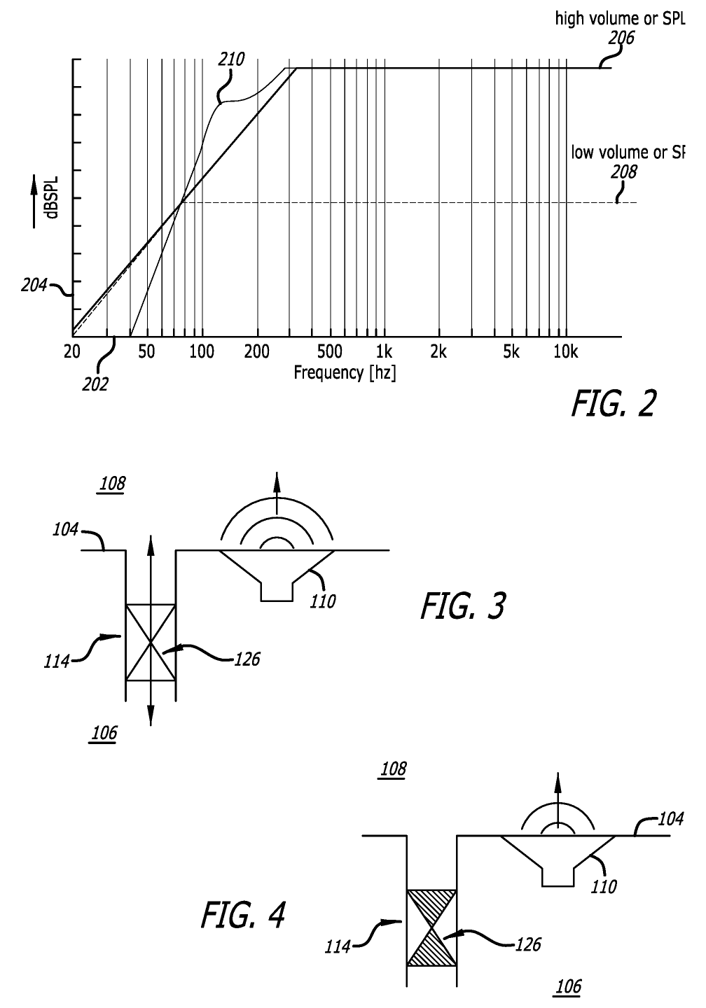

Representatively, as illustrated by the frequency response curve of FIG. 2, when the transducer system is closed (e.g., the pathway 114 to environment 108 is closed), a low frequency output in a range of from about 100 Hertz to about 300 Hertz may be lost when the transducer volume is reduced from a high volume or sound pressure level illustrated by curve 206 to a low volume or sound pressure level illustrated by curve 208. Opening the pathway 114 from chamber 106 to environment 108, however, may increase the low frequency output within this range as illustrated by curve 210. Accordingly, pathway 114 includes valve assembly 126 that is operable to automatically or dynamically open pathway 114 at the high or maximum sound volume level (e.g., sound pressure level illustrated by the horizontal portion of curve 206) and close pathway 114 at the low or minimum volume (e.g., sound pressure level illustrated by the horizontal portion of curve 208) to optimize low frequency output at different volumes. In other words, as illustrated by FIG. 3, at high sound pressure levels (e.g., maximum or high transducer sound volume), the valve assembly 126 transitions to an open configuration to open or maximizes the surface area of pathway 114 to environment 108, which in turn optimizes or improves the low frequency output of transducer 110 when the transducer volume is high (e.g., curve 206). On the other hand, as illustrated by FIG. 4, at low sound pressure levels (e.g., minimum or low transducer sound volume), the valve assembly 126 transitions to a closed configuration to close or minimize the surface area of pathway 114 to environment 108, which in turn optimizes or improves the low frequency output of transducer 110 when the transducer volume is low (e.g., curve 208). In some aspects, valve assembly 126 may be configured to automatically or dynamically transition between open and closed configurations in response to the system measuring or detecting an actual sound pressure level output by transducer 110 (e.g., a high sound pressure level or volume 206 or a low sound pressure level or volume 208), an expected or desired sound pressure level based on models, a hardware high or low sound volume setting, and/or a change in any one of an actual, expected or desired sound pressure level or sound volume level setting.

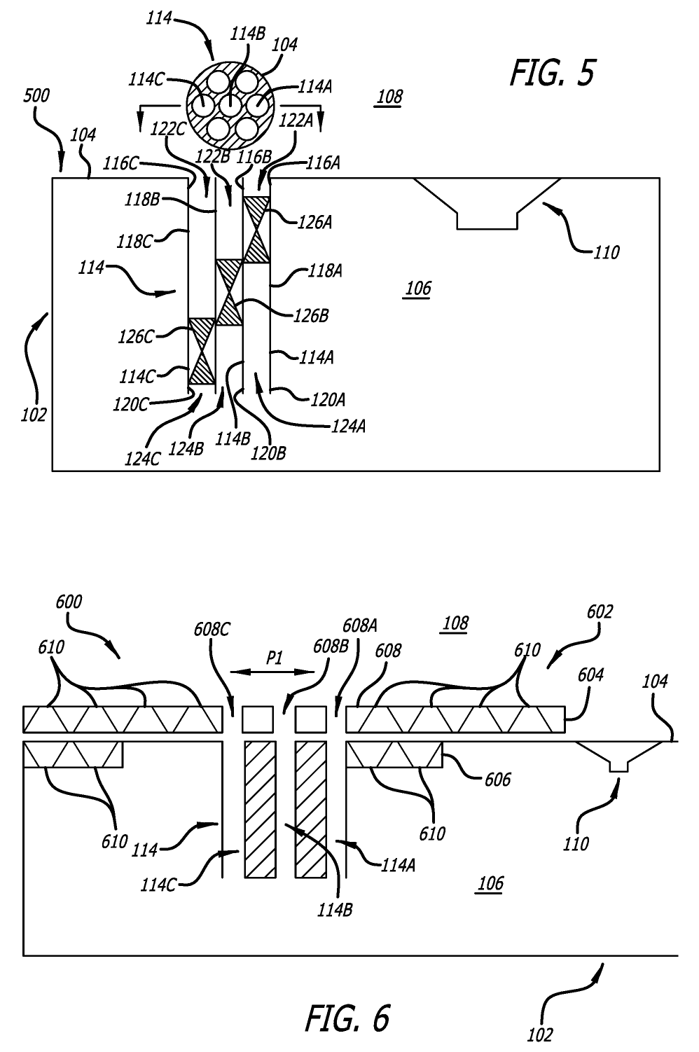

Referring now to FIG. 5, FIG. 5 illustrates a cross-sectional side view of another aspect of an electronic device. Electronic device 500 is similar to electronic device 100 disclosed in reference to FIG. 1 and includes an enclosure 102 having an enclosure wall 104 forming a chamber 106 around transducer 110 and acoustic pathway 114 from chamber 106 to surrounding ambient environment 108. In this configuration, however, acoustic pathway 114 includes a number of acoustic pathways 114A, 114B, 114C and valve assemblies 126A, 126B, 126C to open/close pathways 114A-C. Representatively, a total volume or surface area of acoustic pathway 114 is made up of separate discretized pathways 114A-C, each with a valve assembly 126A-C, that are operable to increase or decrease a total volume of pathway 114 in response to a sound pressure level as previously discussed. In particular, pathway 114 may be made up of pathways 114A-C having first ends 116A, 116B, 116C and second ends 120A, 120B, 120C connected by elongated portions 118A, 118B, 118C. First ends 116A-C may have openings 122A, 122B, 122C formed through enclosure wall 104 to the ambient surrounding environment 108. Second ends 120A-C may have openings 124A, 124B, 124C that are open to interior chamber 106. Each of pathways 114A-C may also have one of valve assemblies 126A-C positioned therein to change or tune a size, geometry, a total volume and/or surface area (e.g., open or close) of pathway 114 by opening or closing one or more of openings 120A-C, 124A-C and/or elongated portions 118A-C in response to a sound pressure level. In this configuration, since there are multiple pathways 114A-C and valve assemblies 126A-C, pathway 114 may be tuned to have different volumes or surface areas in response multiple sound pressure levels between the previously discussed maximum and minimum volume or sound pressure levels (e.g., between levels illustrated by curves 206 and 208). Representatively, instead of only tuning pathway 114 to a maximum volume or surface area (e.g., completely open configuration) or a minimum volume or surface area (e.g., completely closed configuration) as previously discussed, pathway 114 may be tuned to have volumes or surface areas between these thresholds by closing some of pathways 114A-C while other pathways 114A-C remain open. In this aspect, the previously discussed gain in low frequency output at maximum (high) and minimum (low) transducer volumes or sound pressure levels may also be achieved in between these thresholds. For example, in some aspects, when the transducer 110 is at a maximum volume or sound pressure level, all of valves 126A-C may transition to an open configuration which opens or maximizes the total air volume or surface area of pathway 114 between chamber 106 and environment 108. This, in turn, optimizes a low frequency output when transducer 110 is at its loudest or highest volume. When volume or sound pressure level of transducer 110 is reduced or lowered from this maximum volume or sound pressure level, one or more of valves 126A-C may transition to a closed configuration to reduce or decrease the total air volume or surface area of pathway 114. For example, valve 126A may transition to a closed configuration such that pathway 114A is closed while pathways 114B-C remain open to reduce or decrease the overall air volume or surface area of pathway 114 between interior chamber 106 and environment 108. This, in turn, maximizes a low frequency output when transducer 110 is at a volume in between a maximum and minimum volume or loudness setting. If the volume or sound pressure level of transducer 110 is reduced even further, valve 126B may also transition to a closed configuration such that pathways 114A-B are now closed, and pathway 114C is open to further reduce or decrease the overall air volume or surface area of pathway 114. Once the lowest or minimum transducer volume is reached, all of valves 126A-C may transition to a closed configuration to completely close pathway 114 for optimal sound output at the lowest volume. In this aspect, optimal low frequency output may be achieved at different sound pressure levels or volume settings of transducer 110. In addition, it should be understood that while only three pathways 114A-C and valves 126A-C are shown and described in the cross-sectional view of FIG. 5, as can be seen from the top plan view of pathway 114, pathway 114 may be made up of more than three pathways 114A-C, for example, seven or more pathways and each of the pathways may have a valve to open/close and tune an overall volume or surface area of pathway 114 in response to a sound pressure level. In addition, each of valves 126A-C may be independently or separately controlled (e.g., opened and closed) by application of a separate voltage depending on the sound pressure level.

Referring now to FIG. 6, FIG. 6 illustrates a cross-sectional side view of another aspect of an electronic device. Electronic device 600 is similar to electronic device 100 disclosed in reference to FIG. 1 and includes an enclosure having an enclosure wall 104 forming a chamber 106 around the transducer and acoustic pathway 114 from chamber 106 to surrounding ambient environment 108. In addition, acoustic pathway 114 includes a number of acoustic pathways 114A, 114B, 114C as previously discussed. Representatively, a total volume or surface area of acoustic pathway 114 is made up of separate discretized pathways 114A-C between chamber 106 and the surrounding ambient environment 108. In addition, valve assembly 602 is coupled to pathway 114 to change or tune a size, geometry, total volume or surface area (e.g., open or close) of pathway 114 by opening or closing one or more of pathways 114A-C in response to a sound pressure level. In this configuration, however, valve assembly 602 is a sliding valve assembly having a first portion 604 that slides relative to a second portion 606 mounted to enclosure 102 to open/close one or more of pathways 114A-C. Representatively, first portion 604 may be considered a sliding member or gate that is arranged in parallel to enclosure wall 104 forming pathway 114 and slides over the open ends of pathways 114A-C as illustrated by the arrow. The sliding member or gate 604 may be a substantially solid or closed member or portion 608 with a number of openings 608A, 608B, 608C in a pattern such that in some positions openings 608A-C align with one or more of pathways 114A-C so the pathways are open, while in other positions, the solid or closed member 608 aligns with one or more of pathways 114A-C to close the pathways. In some aspects, sliding member or gate 604 and second portion 606 may include a number of magnet and coil pairs 610 that can be energized independently to move sliding member or gate 604 incrementally to the next matched magnet and coil pair 610 and, in turn, the desired position relative to pathways 114A-C.

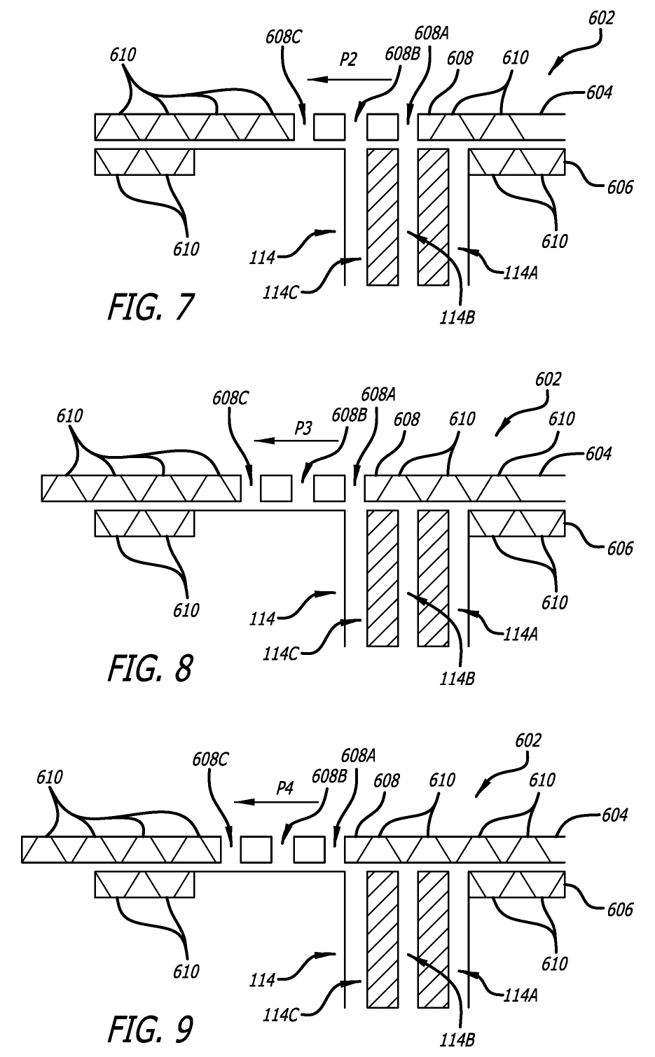

Representatively, FIG. 6 illustrates sliding member or gate 604 in a first position (P1) in which each of openings 608A-C are aligned with each of pathways 114A-C. In this aspect, a volume or surface area of pathway 114 between chamber 106 and environment 108 is maximized. In some aspects, sliding member or gate 604 may transition to the first position (P1) in response to a maximum volume setting or sound pressure level of transducer 110 to optimize the low frequency output as previously discussed. FIG. 7 illustrates sliding member or gate 604 in a second position (P2) in which the solid or closed portion 608 covers pathway 114A and openings 608A-B are aligned with pathways 114B-C. In this aspect, the total volume or surface area of pathway 114 is reduced or decreased by closing one of pathways 114A, while pathways 114B-C remain open. Thus, in some aspects, sliding member or gate 604 may transition to the second position (P1) in response to a change or reduction in the volume or sound pressure level of transducer 110 from a maximum volume or sound pressure level. FIG. 8 illustrates sliding member or gate 604 in a third position (P3) in which the solid or closed portion 608 covers pathways 114A-B and opening 608A is aligned with pathway 114C. In this aspect, the total volume or surface area of pathway 114 is further reduced (as compared to positions P1 and P2) by closing two of pathways 114A-B, while pathway 114C remains open. Thus, in some aspects, sliding member or gate 604 may transition to the third position (P3) in response to a further change or reduction in the volume or sound pressure level of transducer 110 from an already reduced volume. FIG. 9 illustrates sliding member or gate 604 in a fourth position (P4) in which the solid or closed portion 608 covers each of pathways 114A-C. In this aspect, the total volume or surface area of pathway 114 is reduced and pathway 114 is entirely closed. Thus, in some aspects, sliding member or gate 604 may transition to the fourth position (P4) in response to a minimum volume setting or sound pressure level of transducer 110. In this aspect, optimal low frequency output may be achieved at different sound pressure levels or volume settings of transducer 110. In addition, it should be understood that while only three pathways 114A-C and a sliding gate 604 including three openings 608A-C are shown and described in the cross-sectional view of FIG. 6, pathway 114 may be made up of more or less than three pathways 114A-C, for example, two pathways or four or more pathways and sliding gate 604 may include more/fewer openings and slide to additional positions to tune an overall volume or surface area of pathway 114 in response to a sound pressure level.

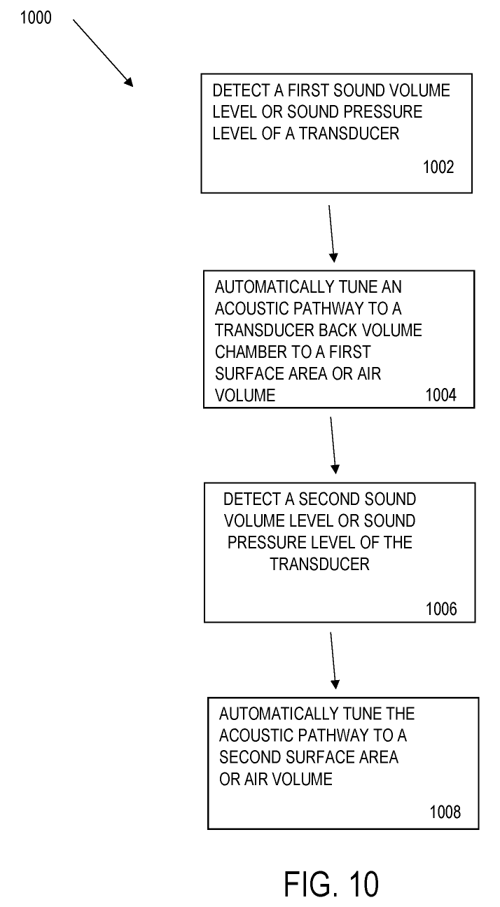

Referring now to FIG. 10, FIG. 10 illustrates one representative process 1000 for dynamically tuning an acoustic pathway to a transducer chamber as a function of the sound volume level or sound pressure level of the transducer. Representatively, process 1000 includes detecting a first sound volume level or desired sound pressure of the transducer at operation 1002. For example, the first sound volume level may be a maximum transducer (e.g, speaker) volume or a maximum actual or desired sound pressure level of the transducer as previously discussed. Once this level is detected, the system may automatically tune an acoustic pathway to the back volume of the transducer to have a first surface area or air volume at operation 1004. For example, a valve such as valve assembly 126 or 602 as previously discussed may be coupled to the acoustic pathway and when a maximum sound volume or sound pressure level is detected at operation 1002, the valve assembly may transition to an open position such that the acoustic pathway has the biggest or maximum surface area or air volume possible at operation 1004. The system may further detect a second sound volume level or desired sound pressure level at operation 1006. For example, the system may detect that the transducer or speaker volume has been lowered to a lower or minimum volume level or desired sound pressure level than the first detected sound volume or sound pressure level. Once this change or lower sound volume or sound pressure level is detected, the system may automatically tune the acoustic pathway to a second surface area at operation 1008. For example, the valve assembly coupled to the acoustic pathway may transition to a closed position such that the acoustic pathway has a minimum surface area or air volume, or at least a surface or volume less than the first surface area or volume. The process 1000 may continue to detect or determine different actual or desired sound volume or sound pressure levels and tune the acoustic pathway accordingly as previously discussed.

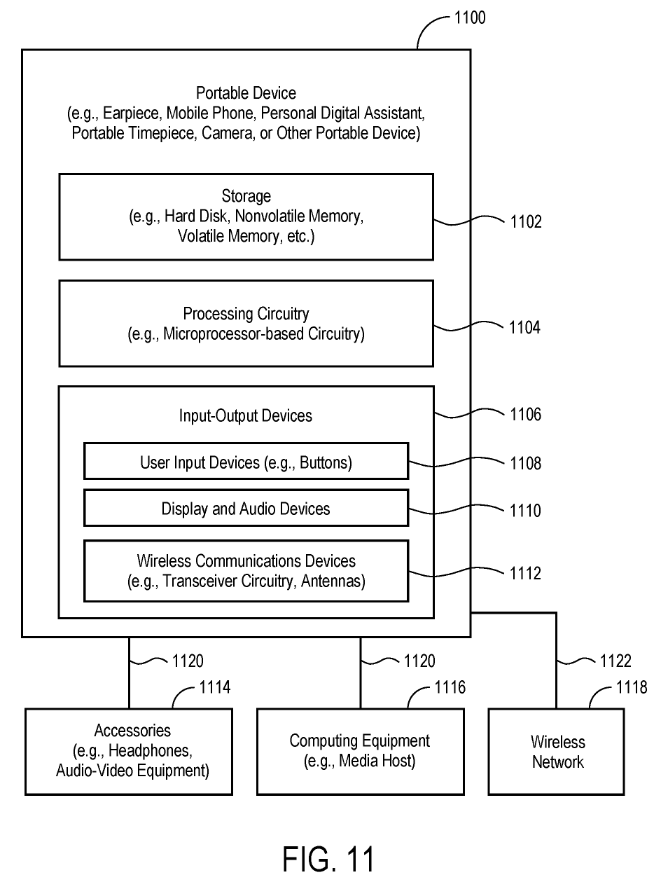

FIG. 11 illustrates a block diagram of one aspect of an electronic device within which the previously discussed transducer and/or valve assembly may be implemented. As shown in FIG. 11, device 1100 may be any type of electronic device within which a transducer and/or valve assembly disclosed herein may be desired, for example, a desktop device such as a computer or speaker, a mobile phone, personal digital assistant, portable timepiece, camera, an earpiece (e.g., in-ear earpiece, hearing aid or the like), or other portable device. Device 1100 may include storage 1102. Storage 1102 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 1104 may be used to control the operation of device 1100. Processing circuitry 1104 may be based on a processor such as a microprocessor and other suitable integrated circuits. With one suitable arrangement, processing circuitry 1104 and storage 1102 are used to run software on device 1100, such as internet browsing applications, voice-over-internet-protocol (VOIP) telephone call applications, email applications, media playback applications, operating system functions, etc. Processing circuitry 1104 and storage 1102 may be used in implementing suitable communications protocols. Communications protocols that may be implemented using processing circuitry 1104 and storage 1102 include internet protocols, wireless local area network protocols (e.g., IEEE 802.11 protocols--sometimes referred to as Wi-Fi®), protocols for other short-range wireless communications links such as the Bluetooth® protocol, protocols for handling 3G or 4G communications services (e.g., using wide band code division multiple access techniques), 2G cellular telephone communications protocols, etc.

To minimize power consumption, processing circuitry 1104 may include power management circuitry to implement power management functions. For example, processing circuitry 1104 may be used to adjust the gain settings of amplifiers (e.g., radio-frequency power amplifier circuitry) on device 1100. Processing circuitry 1104 may also be used to adjust the power supply voltages that are provided to portions of the circuitry on device 1100. For example, higher direct-current (DC) power supply voltages may be supplied to active circuits and lower DC power supply voltages may be supplied to circuits that are less active or that are inactive. If desired, processing circuitry 1104 may be used to implement a control scheme in which the power amplifier circuitry is adjusted to accommodate transmission power level requests received from a wireless network.

Input-output devices 1106 may be used to allow data to be supplied to device 1100 and to allow data to be provided from device 1100 to external devices. Display screens, microphone acoustic ports, speaker acoustic ports, and docking ports are examples of input-output devices 1106. For example, input-output devices 1106 can include user input-output devices 1108 such as buttons, touch screens, joysticks, click wheels, scrolling wheels, touch pads, key pads, keyboards, microphones, cameras, etc. A user can control the operation of device 1100 by supplying commands through user input devices 1108. Display and audio devices 1110 may include liquid-crystal display (LCD) screens or other screens, light-emitting diodes (LEDs), and other components that present visual information and status data. Display and audio devices 1110 may also include audio equipment such as speakers and other devices for creating sound. Display and audio devices 1110 may contain audio-video interface equipment such as jacks and other connectors for external headphones and monitors.

Wireless communications devices 1112 may include communications circuitry such as radio-frequency (RF) transceiver circuitry formed from one or more integrated circuits, power amplifier circuitry, passive RF components, antennas, and other circuitry for handling RF wireless signals. Wireless signals can also be sent using light (e.g., using infrared communications). Representatively, in the case of a speaker acoustic port, the speaker may be associated with the port and be in communication with an RF antenna for transmission of signals from the far end user to the speaker.

Returning to FIG. 11, device 1100 can communicate with external devices such as accessories 1114, computing equipment 1116, and wireless network 1118 as shown by paths 1120 and 1122. Paths 1120 may include wired and wireless paths. Path 1122 may be a wireless path. Accessories 1114 may include headphones (e.g., a wireless cellular headset or audio headphones) and audio-video equipment (e.g., wireless speakers, a game controller, or other equipment that receives and plays audio and video content), a peripheral such as a wireless printer or camera, etc.

Computing equipment 1116 may be any suitable computer. With one suitable arrangement, computing equipment 1116 is a computer that has an associated wireless access point (router) or an internal or external wireless card that establishes a wireless connection with device 1100. The computer may be a server (e.g., an internet server), a local area network computer with or without internet access, a user's own personal computer, a peer device (e.g., another portable electronic device), or any other suitable computing equipment.

Wireless network 1118 may include any suitable network equipment, such as cellular telephone base stations, cellular towers, wireless data networks, computers associated with wireless networks, etc. For example, wireless network 1118 may include network management equipment that monitors the wireless signal strength of the wireless handsets (cellular telephones, handheld computing devices, etc.) that are in communication with network 1118.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. For example, although a speaker is specifically disclosed herein, the valve disclosed herein could be used with other types of transducers, for example, microphones. In addition, in some aspects, the valve could be used to open/close the opening to a chamber other than a back volume chamber of a transducer. Still further, although a desktop device such as a computer or a speaker, or a portable electronic device such as a mobile communications device, are described herein, any of the previously discussed valve and transducer configurations may be implemented within a tablet computer, personal computer, laptop computer, notebook computer, headphones, in-ear earphones and the like. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. An electronic device comprising:
an enclosure having an enclosure wall that forms a back volume chamber around a transducer and an acoustic tube coupling the back volume chamber to an environment surrounding the enclosure wall; and
a valve coupled to the acoustic tube and operable to automatically tune the acoustic tube in response to a sound pressure level of the transducer.

2. The electronic device of claim 1 wherein the acoustic tube comprises a first end having a first opening to the environment and a second end having a second opening to the back volume chamber.

3. The electronic device of claim 1 wherein the valve transitions to an open configuration to maximize an air volume of the acoustic tube in response to a maximum sound pressure level.

4. The electronic device of claim 3 wherein in the open configuration, a first end of the acoustic tube is open to the environment and a second end of the acoustic tube is open to the back volume chamber.

5. The electronic device of claim 1 wherein the valve transitions to a closed configuration to minimize an air volume of the acoustic tube in response to a minimum sound pressure level.

6. The electronic device of claim 5 wherein in the closed configuration, a first end of the acoustic tube is closed to the environment or a second end of the acoustic tube is closed to the back volume chamber by the valve.

7. The electronic device of claim 1 wherein the acoustic tube is a first acoustic tube and the device further comprises a second acoustic tube that together define a total air volume coupling the back volume chamber to the environment that is tuned in response to the sound pressure level.

8. The electronic device of claim 7 wherein the valve is a first valve coupled to the first acoustic tube and a second valve is coupled to the second acoustic tube, and the first valve and the second valve transition to an open configuration to maximize the total air volume of the first acoustic tube and the second acoustic tube in response to a maximum sound pressure level.

9. The electronic device of claim 7 wherein the valve is a first valve coupled to the first acoustic tube and a second valve is coupled to the second acoustic tube, and the first valve and the second valve transition to a closed configuration to minimize the total air volume of the first acoustic tube and the second acoustic tube in response to a minimum sound pressure level.

10. The electronic device of claim 7 wherein the valve is a first valve coupled to the first acoustic tube and a second valve is coupled to the second acoustic tube, the first valve opens the first acoustic tube and the second valve closes the second acoustic tube in response to a sound pressure level between a maximum sound pressure level and a minimum sound pressure level.

11. The electronic device of claim 7 wherein the valve comprises a sliding member having an open portion and a closed portion that slide across open ends of the first acoustic tube and the second acoustic tube to tune the total air volume of the first acoustic tube and the second acoustic tube in response to the sound pressure level.

12. The electronic device of claim 11 wherein the sliding member slides to a number of different positions to open or close the first acoustic tube and the second acoustic tube in response to a number of different sound pressure levels between a maximum sound pressure level and a minimum sound pressure level.

13. The electronic device of claim 11 wherein the sliding member slides in a direction perpendicular to an axis of the first acoustic tube and the second acoustic tube to tune the total air volume of the first acoustic tube and the second acoustic tube.

14. An electronic device comprising:
an enclosure having an interior chamber and an acoustic pathway coupling the interior chamber to an environment surrounding the enclosure;
a speaker coupled to the enclosure, the speaker having a sound output side that outputs sound to the environment surrounding the enclosure and a back side acoustically coupled to the interior chamber and the acoustic pathway; and
a valve coupled to the acoustic pathway and operable to automatically modify an air volume of the acoustic pathway in response to a sound pressure level of the speaker.

15. The electronic device of claim 14 wherein the valve is operable to automatically increase the air volume of the acoustic pathway by opening the acoustic pathway to the environment in response to a maximum sound pressure level of the speaker.

16. The electronic device of claim 14 wherein the valve is operable to automatically decrease the air volume of the acoustic pathway by closing the acoustic pathway to the environment in response to a minimum sound pressure level of the speaker.

17. The electronic device of claim 14 wherein the acoustic pathway comprises a number of acoustic tubes that together define a total air volume coupling the back volume to the environment that is tuned in response to the sound pressure level.

18. The electronic device of claim 17 wherein the valve reduces the total air volume of the acoustic pathway by closing at least one acoustic tube of the number of acoustic tubes in response to a reduction in the sound pressure level from a maximum sound pressure level.

19. The electronic device of claim 17 wherein the valve increases the total air volume of the acoustic pathway by opening at least one acoustic tube of the number of acoustic tubes in response to an increase in the sound pressure level from a minimum sound pressure level.

20. The electronic device of claim 17 wherein the valve comprises a sliding member having an open portion and a closed portion that slide to a number of different positions to open or close the number of acoustic tubes and increase or decrease the total air volume.
